(19) United States
(12) Patent Application Publication
(10) Pub. No.: US 2026/0045565 A1
(43) Pub. Date: Feb. 12, 2026

(54) ENERGY STORAGE DEVICE

(71) Applicant: Eve Energy Storage Co., Ltd., Wuhan (CN)

(72) Inventors: Wei ZHUO, Wuhan (CN); Haohao YI, Wuhan (CN); Yuan ZHU, Wuhan (CN)

(73) Assignee: Eve Energy Storage Co., Ltd., Wuhan (CN)

(21) Appl. No.: 19/362,228

(22) Filed: Oct. 17, 2025

Related U.S. Application Data
(63) Continuation of application No. PCT/CN2024/121367, filed on Sep. 26, 2024.

(30) Foreign Application Priority Data
Mar. 28, 2024 (CN) 202420627133.0

(51) Int. Cl. H01M 10/42; H01M 10/613; H01M 10/651; H01M 10/6567; H01M 50/264

(52) U.S. Cl. CPC H01M 10/425; H01M 10/651; H01M 10/6567; H01M 50/264; H01M 2010/4271; H01M 2010/4278; H01M 10/613

(57) ABSTRACT

The application provides an energy storage device. The energy storage device includes at least one battery compartment and an electrical compartment. The battery compartment includes a battery case and at least one battery unit. The battery case defines a battery installation cavity. The electrical compartment is arranged on a side of the battery compartment. The battery compartment and the electrical compartment are arranged separately. The battery installation cavity is filled with a cooling medium to immerse the at least one battery unit.

This application is a continuation of International Application No. PCT/CN2024/121367, filed on Sep. 26, 2024, which claims priority to and the benefit of Chinese Patent Application No. 202420627133.0, filed on Mar. 28, 2024. The disclosures of the aforementioned applications are incorporated herein by reference in their entireties.

### TECHNICAL FIELD

The present application relates to the technical field of batteries, and in particular to an energy storage device.

### BACKGROUND

Outdoor cabinets are often used in outdoor occasions and are affected by natural weather. For example, high temperatures may cause the temperature of the outdoor cabinet to be too high, and the batteries and other electrical components in the outdoor cabinet will also generate heat. If the outdoor cabinet is in a high temperature environment for a long time, thermal runaway may occur easily.

### SUMMARY

In the related art, cooling is performed by air cooling or using cooling devices, and the cooling efficiency is low. In addition, the battery compartment and electrical compartment of the outdoor cabinet are structured integrally in most cases. When thermal runaway occurs, both of them will experience thermal runaway together, which can easily expand the scope of thermal runaway and pose a great safety hazard.

In a first aspect, the present application provides an energy storage device. The energy storage device includes:
at least one battery compartment, the battery compartment including a battery case and at least one battery cell, the battery case defining a battery installation cavity, in which the at least one battery unit is arranged; and
an electrical compartment, arranged at a side of the battery compartment, and including an electrical case and a plurality of electrical modules, where the electrical case defines an electrical installation cavity, in which the plurality of electrical modules connected to the at least one battery unit are installed;
where the battery compartment and the electrical compartment are separately arranged, and the battery installation cavity is filled with a cooling medium to immerse the at least one battery unit.

### BENEFICIAL EFFECTS

In the technical solutions of the present application, the battery case includes side panels covering lateral sides of the battery installation cavity, and the electrical case includes side panels covering lateral sides of the electrical installation cavity. The side panels of the battery case and the electrical case side panel are opposite to each other and are spaced apart. The battery compartment and the electrical compartment are separately arranged, and the positions of the electrical compartment and the battery compartment can be adjusted according to the actual application environment to improve the versatility of the energy storage device. The battery compartment and the electrical compartment are separately arranged to avoid interference with the other when thermal runaway occurs on one of them, thereby reducing the degree of thermal runaway and improving the safety of the energy storage device. The battery case is filled with a cooling medium which immerses the plurality of battery units, so that the battery units are in direct contact with the cooling medium to improve the cooling efficiency.

### BRIEF DESCRIPTION OF THE DRAWINGS

FIG. 1 is a perspective view of an energy storage device according to some embodiments of the present application.

FIG. 2 is a schematic diagram showing the structure of the battery compartment in FIG. 1, in which no cooling medium is shown.

FIG. 3 is a schematic diagram showing the structure of the battery compartment in FIG. 1, in which the cooling medium is shown.

FIG. 4 is an enlarged view of Part A in FIG. 3.

FIG. 5 is a schematic diagram showing the structure of the battery module in FIG. 1.

FIG. 6 is a schematic diagram showing the structure of the electrical compartment in FIG. 1.

### DESCRIPTION OF REFERENCE NUMERALS

100, energy storage device; 101, battery compartment; 102, battery case; 103, battery unit; 104, battery installation cavity; 105, electrical compartment; 106, electrical module; 107, side panel of battery case; 108, side panel of electrical case; 109, cooling medium; 110, through-hole; 111, battery module; 112, BMS module; 113, high-voltage case module; 114, cooling module; 115, inlet connector; 116, outlet connector; 117, explosion vent; 118, snap-in slot; 119, battery cell; 120, fixing member; 121, signal acquisition board; 122, support assembly; 123, support frame; 124, support plate.

### DETAILED DESCRIPTION OF THE EMBODIMENTS

If the temperature of the outdoor cabinet is too high, the batteries and other electrical components in the outdoor cabinet will also generate heat. If the outdoor cabinet is in a high temperature environment for a long time, thermal runaway is prone to occur. In the related technology, cooling is performed by air cooling or using cooling devices, and the cooling efficiency is low. In addition, the battery compartment and electrical compartment of the outdoor cabinet are structured integrally in most cases. When thermal runaway occurs, both of them will experience thermal runaway together, which is easy to expand the scope of thermal runaway and pose a great safety hazard.

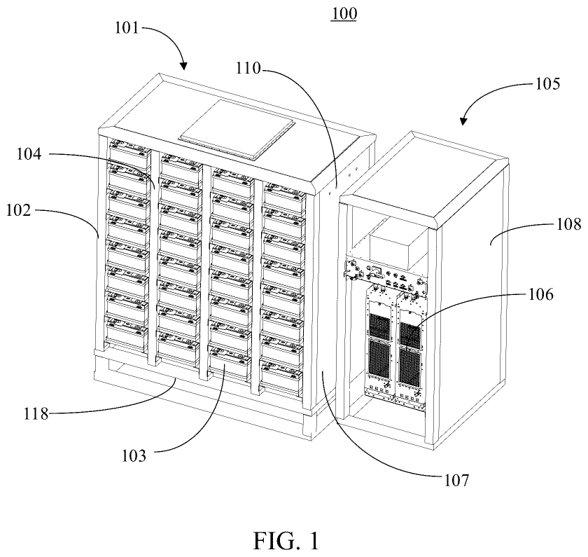

In view of this, the present application proposes an energy storage device 100. FIGS. 1 to 6 are schematic diagrams showing structures of the energy storage device 100 according to an embodiment of the present application. The energy storage device 100 according to the present application has high cooling efficiency and high safety factor. The energy storage device 100 will be described in detail below by referring to the figures.

Please refer to FIG. 1, the present application provides an energy storage device 100, which includes at least one battery compartment 101 and an electrical compartment 105. The battery compartment 101 includes a battery case 102 and a plurality of battery units 103. The battery case 102 defines a battery installation cavity 104, in which the plurality of battery units 103 are arranged. The electrical compartment 105 is arranged on a side of the battery compartment 101, and includes an electrical case and a plurality of electrical modules 106. The electrical case defines an electrical installation cavity, in which the plurality of electrical modules 106 electrically connected to the plurality of battery units 103 are installed. The battery compartment 101 and the electrical compartment 105 are separately arranged, and the battery installation cavity 104 is filled with a cooling medium 109 to immerse the plurality of battery units 103.

In the technical solutions of the present application, the battery case 102 includes side panels 107 covering lateral sides of the battery installation cavity 104, and the electrical case includes side panels 108 covering lateral sides of the electrical installation cavity. The side panels 107 of the battery case and the side panels 108 of the electrical case are opposite to each other and are spaced apart. The battery compartment 101 and the electrical compartment 105 are separately arranged, and the positions of the electrical compartment 105 and the battery compartment 101 can be adjusted according to the actual application environment to improve the versatility of the energy storage device 100. In addition, the battery compartment 101 and the electrical compartment 105 are separately arranged to avoid interference with the other when thermal runaway occurs on one of them, thereby reducing the degree of thermal runaway and improving the safety of the energy storage device 100. The battery case is filled with a cooling medium 109 which immerses the plurality of battery units 103, so that the battery units 103 are in direct contact with the cooling medium 109 to improve the cooling efficiency.

Specifically, please continue to refer to FIG. 1, the battery case 102 includes side panels 107 covering lateral sides of the battery installation cavity 104, and the electrical case includes side panels 108 covering lateral sides of the electrical installation cavity. The side panels 107 of the battery case and the side panels 108 of the electrical case are opposite to and spaced apart from each other, so that the battery compartment 101 and the electrical compartment 105 are separated. The battery compartment 101 can be arranged on the front, rear, left or right side of the electrical compartment 105. Specifically, the battery compartment 101 and the electrical compartment 105 can be reasonably arranged according to the actual situation on site.

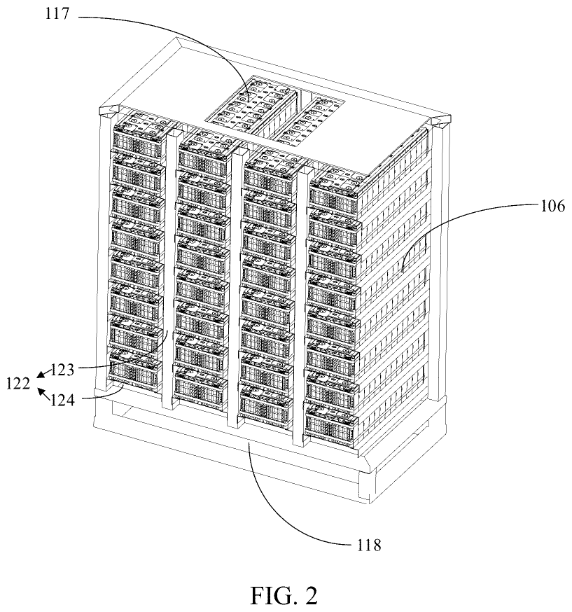

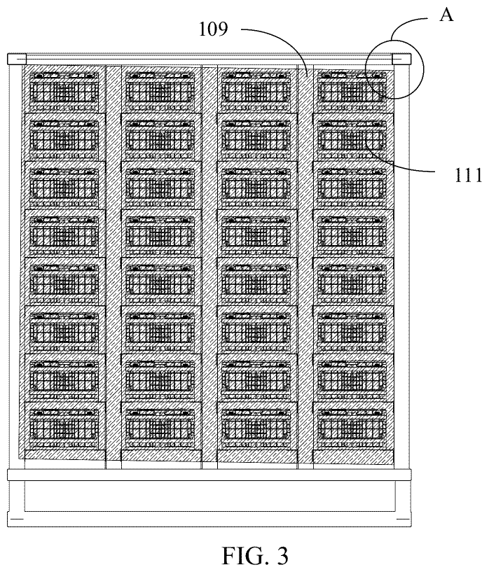

In some embodiments, the electrical compartment 105 is configured to control the operation of the battery compartment 101 and monitor the status of the plurality of battery units 103 in the battery compartment 101. The battery compartment 101 is electrically connected to the electrical compartment 105, and the battery installation cavity 104 is filled with a cooling medium 109. Therefore, in the process of electrical connection, not only the convenience of connection should be considered, but also the location of the through-hole 110 should be considered to avoid leakage of the cooling medium 109 from the battery installation cavity 104. Specifically, please refer to FIGS. 2 and 3, at least one of the side panels 107 of the battery case defines a plurality of through-holes 110 arranged at intervals. The through-holes 110 are configured to allow at least one connecting wire to pass through so as to be electrically connected to the plurality of battery units 103 and at least one electrical module 106. Taking the high-voltage wire as an example, one end of the high-voltage wire passes through one of the through-holes 110, enters the battery installation cavity 104, and is connected to the battery unit 103 in the battery installation cavity 104, and the other end of the high-voltage wire enters the electrical case and is connected to one of the electrical modules 106.

It should be noted that the top surface of the cooling medium 109 is lower than or flush with the horizontal plane where the bottom of the through-holes 110 is located. In one embodiment, the top surface of the cooling medium 109 is lower than the horizontal plane where the bottom of the through-holes 110 is located, which can prevent the cooling medium 109 from seeping out of the through-hole 110. It should be noted that the application environment of the energy storage device 100 is generally outdoors. When a vehicle passes by the energy storage device 100, the battery compartment 101 will shake due to resonance and other phenomena. If the top surface of the cooling medium 109 is flush with the horizontal plane where the bottom of the through-holes 110 is located, the cooling medium 109 will seep out from the through-hole 110 during the shaking of the battery compartment 101, thereby affecting the cooling effect.

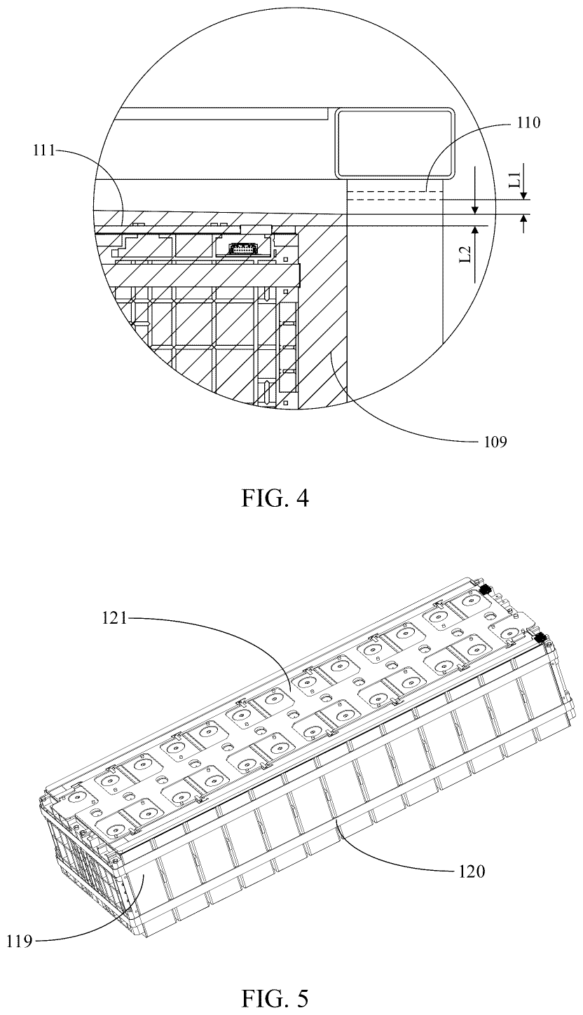

In some embodiments, please refer to FIG. 4, the distance between the top surface of the cooling medium 109 and the horizontal plane where the bottom of the through-holes 110 is located is defined as L1, where L1≥30 mm. When the distance between the top surface of the cooling medium 109 and the horizontal plane where the bottom of the through-holes 110 is located is less than 30 mm, the cooling medium 109 will seep out of the through-hole 110 when the battery compartment 101 vibrates due to resonance and other phenomena. It should be noted that in order to avoid the occurrence of seepage, the larger the value of L1, the better, but when the value of L1 increases, the volume of the battery compartment 101 will also increase accordingly, so the value of L1 is adaptively adjusted according to the actual application occasions and environment. In one embodiment, the distance between the top surface of the cooling medium 109 and the horizontal plane where the bottom of the through-hole 110 is 30 mm. The L1 is set at this value so as to avoid occupying too much space and avoid leakage of the cooling medium 109 due to being too close to the top surface of the cooling medium 109.

In some embodiments, each battery unit 103 includes a plurality of battery modules 111 stacked along the height of the battery compartment 101. The top surface of the battery module 111 at the top of the plurality of battery units 103 is the first surface, and the top surface of the cooling medium 109 is flush with or higher than the first surface. In one embodiment, the top surface of the cooling medium 109 is higher than the first surface. Such an arrangement can ensure that the topmost battery module 111 can also be immersed in the cooling medium 109, thereby ensuring the cooling efficiency. It should be noted that when the top surface of the cooling medium 109 is flush with the first surface, if the battery compartment 101 shakes due to resonance or other phenomena, the cooling medium 109 will also shake, causing the battery module 111 at the top to be partially exposed to the outside of the cooling medium 109, thereby reducing the cooling efficiency.

In some embodiments, please refer to FIG. 4, the distance between the top surface of the cooling medium 109 and the first surface is defined as L2, where L2≥ 20 mm. When the distance between the top surface of the cooling medium 109 and the first surface is less than 20 mm, when the battery compartment 101 vibrates due to resonance or other phenomena, the cooling medium 109 will vibrate along with the battery compartment 101, causing a portion of the battery module 111 at the top to be exposed outside the cooling medium 109, affecting the cooling efficiency. The larger the value of L2, the better, and any part of the plurality of battery units 103 can be immersed in the cooling medium 109. However, it should be noted that when the value of L2 increases, the volume of the battery installation cavity 104 also needs to increase accordingly, which will cause the volume of the battery compartment 101 to increase accordingly. Therefore, the value of L2 is adaptively adjusted according to the actual application occasions and environment. When the environment in which the battery compartment 101 is located is relatively still and there are no extra objects that will cause the battery compartment 101 to resonate, the value of L2 can be correspondingly reduced. When the environment in which the battery compartment 101 is located is relatively complex, the value of L2 may be correspondingly increased to avoid partial areas of the battery module 111 located at the top being exposed outside the cooling medium 109. In one embodiment, the distance between the top surface of the cooling medium 109 and the first surface is 20 mm. The L2 is set at this value so that the cooling efficiency requirements can be met while avoiding taking up too much space.

Please refer to FIGS. 1 and 2, in some embodiments, the energy storage device 100 also includes a plurality of support assemblies 122 arranged in the battery installation cavity 104. The support assemblies 122 are configured to support a plurality of battery modules 111. Specifically, each support assembly 122 includes a support frame 123 and a plurality of support plates 124. A plurality of mounting positions are formed on the support frame 123. The plurality of support plates 124 are mounted at the plurality of mounting positions respectively. A mounting cavity is formed between two adjacent support plates 124. Each of the battery modules 111 is arranged in one mounting cavity.

In this embodiment, four groups of battery units 103 are provided. The four groups of battery units 103 are arranged at intervals along the length direction of the battery compartment 101, and each group of battery units 103 includes eight battery modules 111.

In some embodiments, please refer to FIG. 5, each battery module 111 includes a plurality of battery cells 119 and a fixing member 120. The plurality of battery cells 119 are arranged in parallel, and the fixing member 120 surrounds the outer sides of the plurality of battery cells 119 to fix the plurality of battery cells 119. Each battery module 111 also includes a signal acquisition board 121 arranged at the upper ends of the plurality of battery cells 119 to be connected to the electrodes of the plurality of battery cells 119. The signal acquisition board 121 is connected to the connecting wire so as to transmit the information of the battery module 111 to the electrical compartment 105.

In some embodiments, the fixing member 120 is an insulating steel strip, which can ensure the connection strength and avoid causing a short circuit.

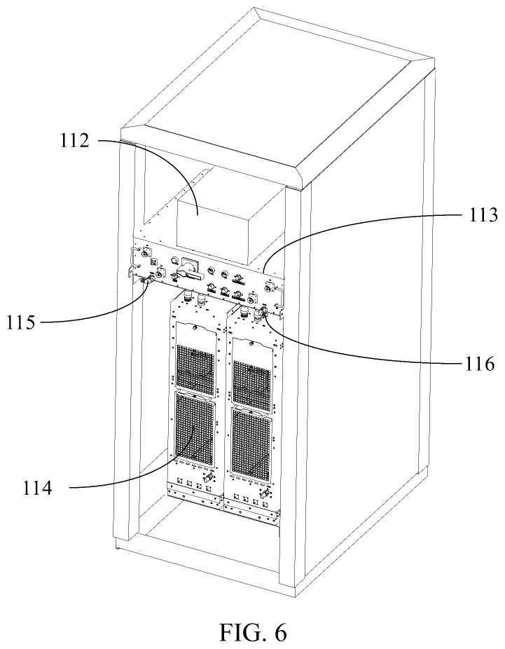

Please refer to FIGS. 1 and 6, in some embodiments, the plurality of electrical modules 106 include a BMS (Battery Management System) module 112, a high-voltage case module 113, and a cooling module 114. The high-voltage case module 113 is located above the cooling module 114, and the BMS module is located above the high-voltage case module 113. Placing the high-voltage case module 113 and the BMS module above the cooling module 114 can improve the safety of the electrical compartment 105. When the cooling medium 109 in the cooling module 114 leaks, the cooling medium 109 avoids interfering with the BMS module or the high-voltage case module 113, thereby improving the safety of the energy storage device 100. Specifically, the high-voltage case module 113 includes a case and a communication interface installed on the case, and at least one connecting wire is electrically connected to the communication interface through the BMS module.

Please refer to FIG. 6, the energy storage device 100 also includes a cooling connection assembly, which includes an inlet connector 115 and an outlet connector 116. The inlet connector 115 and the outlet connector 116 are installed on the case of the high-voltage case module 113. It should be noted that the inlet connector 115 and the outlet connector 116 are arranged on the case of the high-voltage case module 113 so that the case of the high-voltage case module 113 provides a place for fixing the cooling connection assembly to avoid shaking of the cooling connection assembly, thereby avoiding leakage of the cooling medium 109 and improving the safety of the energy storage device 100. More specifically, the battery case is formed with an inlet and an outlet. One end of the inlet connector 115 is connected to the inlet of the battery case, and the other end of the inlet connector 115 is connected to the cooling module 114. One end of the outlet connector 116 is connected to the outlet of the battery case, and the other end of the outlet connector 116 is connected to the cooling module 114. As a result, the inlet of the battery case is in communication with the inlet connector 115, and the outlet of the battery case is in communication with the cooling module 114. Specifically, the cooling medium 109 in the battery case flows out from the outlet of the battery case, passes through the outlet connector 116, flows into the cooling module 114 to be cooled in the cooling module 114, and then flows out from the cooling module 114, passes through the inlet connector, and flows into the battery case from the inlet of the battery case, completing the cooling cycle.

It should be noted that when thermal runaway occurs, a lot of gas will be generated inside the battery compartment 101. When the concentration of the gas reaches a certain level, the battery compartment 101 will explode if the gas cannot be discharged in time. In order to avoid the explosion of the battery compartment 101, an explosion vent 117 is defined at the top of the battery compartment 101, and the explosion vent 117 is covered with a cover. When thermal runaway occurs, the cover is opened and the gas generated in the battery compartment 101 flows out from the explosion vent 117, thereby avoiding explosions and the like, and improving the safety of the energy storage device 100.

In some embodiments, a snap-in slot 118 is defined at the bottom of the battery compartment 101, and the snap-in slot 118 is configured to allow a moving device to be snapped therein so as to transport the battery compartment 101. The purpose of providing the snap-in slot 118 is to facilitate transportation and splicing of multiple battery compartments 101, and the position of the battery compartment 101 can be adjusted according to actual conditions, thereby realizing reasonable use of space.

It should be noted that the present embodiment adopts an immersion cooling, and the cooling medium 109 immerses the plurality of battery units 103. Therefore, in order to improve safety, the cooling medium 109 is an insulating medium. In some embodiments, the insulating medium is synthetic oil.

What is claimed is:

1. An energy storage device, comprising:
at least one battery compartment, each comprising a battery case and at least one battery unit, the battery case defining a battery installation cavity so that the at least one battery unit is arranged therein; and
an electrical compartment, arranged on a side of the battery compartment, the electrical compartment comprising an electrical case and a plurality of electrical modules, the electrical case defining an electrical installation cavity so that the plurality of electrical modules are installed therein, the plurality of electrical modules being electrically connected to the at least one battery unit;
wherein the battery compartment and the electrical compartment are arranged separately, and the battery installation cavity is filled with a cooling medium to immerse the at least one battery unit.

2. The energy storage device according to claim 1, wherein the battery case comprises side panels, wherein the electrical case comprises side panels, wherein the side panels of the battery case and the side panels of the electrical case are arranged opposite to and spaced apart from each other, so that the battery compartment and the electrical compartment are arranged separately.

3. The energy storage device according to claim 1, wherein a through-hole is defined on a side of the battery case closer to the electrical case, and the through-hole is configured to allow at least one connecting wire to pass through so as to electrically connect to the at least one battery unit and at least one of the plurality of electrical modules.

4. The energy storage device according to claim 3, wherein a top surface of the cooling medium is lower than or flush with a horizontal plane where a bottom of the through-hole is located.

5. The energy storage device according to claim 4, wherein a distance between the top surface of the cooling medium and the horizontal plane where the bottom of the through-hole is located is defined as L1, where L1≥30 mm.

6. The energy storage device according to claim 4, wherein each of the at least one battery unit comprises a plurality of battery modules stacked along a height of the battery compartment, wherein a top surface of a topmost one of the plurality of battery modules of the at least one battery unit is defined as a first surface, and the top surface of the cooling medium is flush with or higher than the first surface.

7. The energy storage device according to claim 6, wherein a distance between the top surface of the cooling medium and the first surface is defined as L2, where L2≥20 mm.

8. The energy storage device according to claim 6, further comprising a plurality of support assemblies arranged in the battery installation cavity, and wherein the plurality of support assemblies are configured to support and fix the plurality of battery modules.

9. The energy storage device according to claim 8, wherein each of the plurality of support assemblies comprises a support frame and a plurality of support plates, wherein the plurality of support plates are arranged on the support frame at intervals so that an installation cavity configured to receive a corresponding one of the plurality of battery module is formed between adjacent two of the plurality of support plates, and each of the plurality of battery modules is fixed onto at least one of the plurality of support plates.

10. The energy storage device according to claim 6, wherein each of the plurality of battery modules comprises a plurality of battery cells arranged side by side.

11. The energy storage device according to claim 10, wherein each of the at least one of battery unit further comprises a plurality of fixing members each surrounding an outer side of a corresponding one of the plurality of battery modules so that the plurality of battery cells can be fixed by the plurality of fixing members.

12. The energy storage device according to claim 10, wherein each of the at least one of battery unit further comprises a plurality of signal acquisition boards each arranged on a corresponding one of the plurality of battery modules, wherein each of the plurality of signal acquisition boards has an end electrically connected to an electrode of a corresponding one of the plurality of battery cells, and a further other end electrically connected to a corresponding one of the at least one connecting wire.

13. The energy storage device according to claim 11, wherein at least one of the plurality of fixing members is an insulating steel strip.

14. The energy storage device according to claim 1, wherein the plurality of electrical modules comprise a BMS module, a high-voltage case module and a cooling module, wherein the high-voltage case module is located above the cooling module, the BMS module is located above the high-voltage case module, the high-voltage case module comprises a case and a communication interface installed thereon, and at least one connecting wire is electrically connected to the communication interface through the BMS module.

15. The energy storage device according to claim 14, further comprising a cooling connection assembly, wherein the cooling connection assembly comprises an inlet connector and an outlet connector, wherein the inlet connector and the outlet connector are mounted on the case of the high-voltage case module;
wherein the battery case is formed with an inlet and an outlet, the inlet connector has an end connected to the inlet of the battery case, and a further end connected to the cooling module, and the outlet connector has an end connected to the outlet of the battery case, and a further end connected to the cooling module.

16. The energy storage device according to claim 1, wherein an explosion vent is defined at a top of the battery compartment, and the explosion vent is covered with a cover.

17. The energy storage device according to claim 1, wherein the cooling medium is an insulating medium comprising synthetic oil.

18. The energy storage device according to claim 16, wherein a snap-in slot is defined at a bottom of the battery compartment, and the snap-in slot is configured to allow a snap-fit between a moving device and the battery compartment so as to transport the battery compartment.

19. The energy storage device according to claim 1, wherein a snap-in slot is defined at a bottom of the battery compartment, and the snap-in slot is configured to allow a snap-fit between a moving device and the battery compartment so as to transport the battery compartment.

20. The energy storage device according to claim 2, wherein the cooling medium is an insulating medium comprising synthetic oil.
